(19) United States
(12) Patent Application Publication
(10) Pub. No.: US 2021/0132712 A1
(43) Pub. Date: May 6, 2021

(54) Touch Pad Cell Phone

(71) Applicant: James Filomio, JR., Bronx, NY (US)

(72) Inventor: James Filomio, JR., Bronx, NY (US)

(21) Appl. No.: 17/107,749

(22) Filed: Nov. 30, 2020

Related U.S. Application Data
(63) Continuation-in-part of application No. 16/137,582, filed on Sep. 21, 2018.

(51) Int. Cl. G06F 3/0354; G06F 3/02

(52) U.S. Cl. CPC G06F 3/03547; G06F 3/0202

(57) ABSTRACT

The said invention has a force-sensitive touch surface built into a hand held electronic device that works along with a cursor on the viewing element that the user can activate with their finger(s), by manipulating the movement of the cursor with their finger movement on the touch surface and control the feathers of their phone one handed by applying pressure to the clicker button (aka a mouse click) when the cursor is positioned over the icon or command of choice.

A hand held electronic device with a built-in force-sensitive touch surface, a cursor and a clicker button (aka a mouse click) that allows the user to control the operations of the electronic device with one hand.

### BACKGROUND OF INVENTION

The said invention is designed so an electronic hand-held device can be operated with one hand. The force-sensitive touch surface allows the user to operate all the devices features with their (e.g., finger(s)). The force-sensitive touch surface, works along with a cursor and the clicker button to navigate the device and select the desired application. The said invention may display physical buttons that control the (e.g., power, mute).

### BRIEF SUMMARY OF INVENTION

The said invention has a forced-sensitive touch surface similar to that of a computer along with a cursor, and a clicker button built into the device. The force-sensitive touch surface is positioned so that the user can use one hand to control the device. The force-sensitive touch surface is built into the device and is positioned on the side opposite the viewing screen, and is aligned with the user's fingers, (e.g., index finger) when the device is held. The force-sensitive touch surface has a clicker button (aka a mouse click), and used along with a cursor it allows the user to for example (e.g., open or close pages, select a phone option, manage contacts and messages, control applications, settings, programs and displays). The force-sensitive touch surface, mouse click and cursor, is designed for the user to more easily use their phone or electronic devices.

### BRIEF DESCRIPTION OF SEVERAL VIEWS OF THE DRAWINGS

FIG. 1 of the drawings illustrates the front and rear view of the invention. The rear view shows the force-sensitive touch surface (T) with built in clicker (mouse click). The clicker (aka a mouse click) is felt by the user because the button is marked with small etching and or a bump. The on/off switch (B), that shuts off power to the touch surface. (R) is the device's housing and (C) is the camera. Also FIG. 1 illustrates the front view of the said invention. On the front view it illustrates the cursor (A) that is controlled by the user's finger movement on the force-sensitive touch surface (T), and is displayed in the device's display element. When the cursor (A) is positioned over the icon or command wanted, the user press the force-sensitive touch surface (T) to activate the clicker, (aka the mouse click) and achieve the command given.

FIG. 2 of the drawings illustrates a rear view of the said invention and the user's hand position and movement on the force-sensitive touch surface (T) that controls the cursor (A) in the display element with movement.

### DETAILED DESCRIPTION OF THE INVENTION

The said invention has a force-sensitive touch surface (T) that is built in and wired directly into an electronic device.

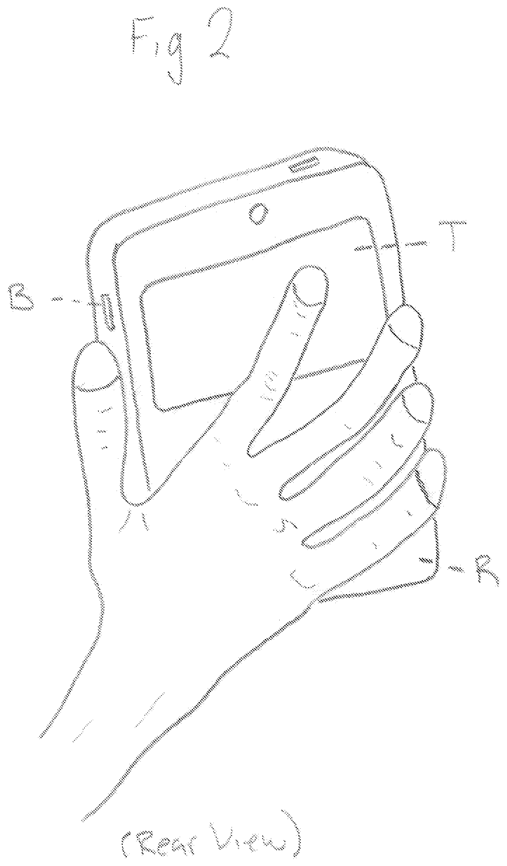

The force-sensitive touch surface (T) is located on the opposite side of the display element on a hand-held electronic device and is operated by the user's finger(s) movement as shown in FIG. 2.

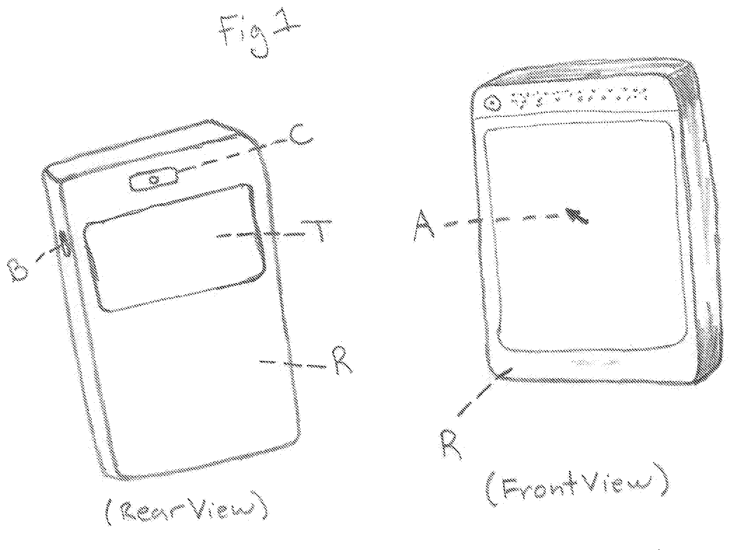

The force-sensitive touch surface (T) when manipulated by the user's finger(s), will move the cursor (A) FIG. 1, over the display element. When the cursor (A) is positioned over an icon or command, the user applies pressure to the touch surface (T) activating the clicker button (aka a mouse click) completing the task given, for example, (opening or closing a window, applications, scrolling, settings, play lists, contacts).

The said inventions clicker button (aka a mouse click) may also be separate from the force-sensitive touch surface T) and positioned along the side of the device's housing (R) for easier use and reach for the user. There may also be multiple clicker buttons, one on each side, that work in the same manner as the touch surface clicker button. When the cursor is positioned over an icon or command, the user pressed one of the two side mounted clicker buttons (aka mouse click) to active the command, (e.g., opening a new window, choosing a contact, typing in a password).

When the user makes contact with the force-sensitive touch surface (T) the device will power up.

The cursor (A) is time sensitive and the display can be altered in the cursor information Setting's, along with the cursor's icon image and length of display on the display element.

Because of the design and location of the force-sensitive touch surface (T), the device can be held and used in any angle.

The force-sensitive touch surface (T) is able to work with two fingers on the surface at one time to command the device to options that require multiple fingers to complete a command, (e.g., zooming in or out, realigning the display element).

The said invention is not limited to physical buttons or switches, (e.g., power, mute).

The user manipulates the cursor (A) by their finger movement on the force-sensitive touch surface (T). The movement and location of the cursor (A) on the display element is determined by the user's finger movement and location on the force-sensitive touch surface (T).

The display cursor which shows the position of the user's finger against the back-side touch-surface relative to the click button which are transparently (denoted by an etching or bump in the force-sensitive touch-surface) so that the user may continue to view whatever information was being displayed at the time they activated the back-side control, and once the user manipulates the cursor by sliding their finger across the force-sensitive touch surface to the desired position (e.g., the “contact page”) all the user needs to do is apply pressure with their finger to the force-sensitive touch surface (aka a “the clicker”) without lifting their finger from the surface

Illustrative operational states include, but are not limited to—on, off, locked, phone mode, video mode, audio play mode, calendar mode, email mode, address book mode and image capture mode; thus, a signal user action may have cause different control elements to be displayed (or no control element at all), depending on the device's current operational state.

The clicker button (aka a mouse click) may be used in applications where the “mouse click” might need to be held down (e.g. screen sizing, scrolling) while the user manipulates the force-sensitive touch surface.

The display cursor shows the position of the user's finger(s) against the force-sensitive touch surface relative to the click button which are transparently (denoted by an etching or bump in the force-sensitive touch-surface).

The clicker button (aka a mouse click) is activated by the user applying finger pressure against the force-sensitive touch surface, or if the clicker button(s) are located on the side of the housing, by the user pressing one or both of the buttons.

The cursors operation information (settings) can adjust the cursor, (e.g., icon image and length of display).

I claim:

1. A force-sensitive touch surface that is built into a hand-held electronic device that when activated will control a cursor on the display element that is used to work the features and operation systems of the device.

2. The device in claim 1, wherein said invention may include physical buttons/switches in addition to a force-sensitive touch surface (e.g., power, mute); force-sensitive touch surface said on/off switch controls the touch surface and when turned off, the operation of the touch surface will be turned off and unable to use, when the on/off switch is turned off, the touchpad will not respond to touch or movement.

3. The device in claim 1, wherein said device has a cursor that is located on the display element opposite the force-sensitive touch surface (see the cursor, touch surface in FIG. 1).

4. The device in claim 1, wherein said device has a clicker button (aka a “mouse-click”) feature that may be represented on the touch surface by, for example, an etched or raised outline, once the user manipulates cursor by sliding their finger across force-sensitive touch surface to a desired position (e.g. the “play” control element position), all the user needs to do is apply pressure to the force-sensitive touch surface (mouse click), to active the desired action.

5. The device in claim 1, wherein said device, the cursor which shows the position of the user's finger against the back-side touch-surface, the user manipulates the cursor by sliding their finger across the force-sensitive touch-surface to a desired position (e.g. the “pause” control element), all the user need to do is apply pressure with their finger to the force-sensitive touch surface to active the action, thus, a user may move the display cursor and make a selection (aka a “mouse click”) without lifting their finger from the surface.

6. The device in claim 1, wherein said device, the clicker button (aka a mouse click) may be represented on the force-sensitive touch surface, but not limited to be represented into the housing of the phone and is activated by the user pressing or tapping the button in the same manner, thus the user may move the displayed curser with the force-sensitive touch surface, positioning the cursor over a desired action and pressing the button (aka a mouse click) with their finger.

7. The device in claim 1, wherein said force-sensitive touch surface is not limited to location, size, shape, texture, being concaved or convexed, (see FIG. 1; please note that the claim does not limit the device or touch surface to any location, size or shape such as the device or touch surface configuration as shown in FIG. 1 is one possible configuration).

8. The device in claim 1, wherein said device, the clicker button (aka a mouse click), may be pressed and held down to activate, (e.g., volume control, highlighting text or scrolling position), while the user manipulates the cursor by sliding their finger(s) across the force-sensitive touch surface.

9. The device in claim 1, wherein said device, a force-sensitive touch surface is a surface that is adapted to simultaneously detect where one or more objects touch it (e.g., fingers) and the force those objects apply to the surface.

10. The device in claim 1, wherein said device, in accordance with the invention may include physical buttons/switches in addition to a force-sensitive touch surface (e.g., power, reset button), contact with the force-sensitive touch surface by (e.g., the user's finger) will power up the device.

11. The device in claim 1, wherein said device, the system may determine a motion of the first finger in relation to a motion of a second finger different than the first finger and assigned a command to control the electronic device in accordance with the determine motion, for example the user may either move their two fingers apart on the back-side touch surface to change the display image, e.g., magnify or zoom-in on a displayed image, move the two fingers closer together to zoom out, or rotate the fingers around a rotation point intermediate between the two fingers to rotate an image.

12. The device in claim 1, wherein said device, the user positions the cursor through movement of their finger across the device's back-side force-sensitive touch surface; button selection (aka a mouse click) is made through the application of pressure to the back-side touch surface.

13. The device in claim 1, wherein said device, the cursor can be moved by the user pressing their finger over the cursor and sliding their finger to the location they want the cursor to move, when the user removes their finger from the cursor it will stay in that location.

14. The device in claim 1, wherein said device, a display element is used to present one or more control elements and a cursor that is controlled through manipulation of the force-sensitive touch surface.

15. The device in claim 1, wherein said device, a means to operate a hand-held electronic device with one hand, wherein cursor movement and control element selection/activation may be accomplished without lifting one's finger.

16. The device in claim 1, wherein said device, can be operated with a hand-held electronic device held at any angle.

17. The device in claim 1, wherein said device, the cursors operation information (settings) can adjust the cursor, (e.g., icon image and length of display).

18. The device in claim 1, wherein said device, the cursor-setting operation based on the cursor-operation information, in a case where the forced-sensitive touch surface has detected no contact for a specific amount of time, a cursor-removal operation is detected and the cursor will disappear, the cursor will reappear with contact to the force-sensitive touch surface, the motivation of combing these analogous arts is to provide a touch panel apparatus with high usability.

19. The device in claim 1, wherein the said device, the clicker button was designed to be located in the touchpad itself, but is not limited to location, size or shape, and also not limited to being separate from the rear mounted touchpad and being placed in other areas of the housing.

20. The device in claim 1, wherein the said device, the clicker button, is not limited to having two buttons, one on each side of the housing.

21. The device in claim 1, wherein the said device, Illustrative operational states include, but are not limited to, on-off, locked, phone mode, video mode, audio play mode, calendar mode, email mode, address book mode and image capture mode; thus, a signal user action may have cause different control elements to be displayed (or no control element at all), depending on the device's current operational state.

22. The device in claim 1, wherein the said device, the display cursor which shows the position of the user's finger against the back-side touch-surface relative to the click button which are transparently (denoted by an etching or bump in the force-sensitive touch-surface) so that the user may continue to view whatever information was being displayed at the time they activated the back-side control, and once the user manipulates the cursor by sliding their finger across the force-sensitive touch surface to the desired position (e.g., the “contact page”) all the user needs to do is apply pressure with their finger to the force-sensitive touch surface (aka a “the clicker”) without lifting their finger from the surface.
